(19) United States
(12) Patent Application Publication
(10) Pub. No.: US 2026/0104194 A1
(43) Pub. Date: Apr. 16, 2026

(54) Housing for a Climate Chamber and Climate Chamber

(71) Applicant: Binder GmbH, Tuttlingen (DE)

(72) Inventors: Ahmet ARABUL, Tuttlingen (DE); Jochen BUSCHLE, Tuttlingen (DE); Ewald STORZ, Rietheim-Weilheim (DE)

(73) Assignee: Binder GmbH, Tuttlingen (DE)

(21) Appl. No.: 19/340,060

(22) Filed: Sep. 25, 2025

(30) Foreign Application Priority Data
Oct. 14, 2024 (DE) 1020241297166

(51) Int. Cl. F25D 23/06; G01N 1/42

(52) U.S. Cl. CPC F25D 23/062; G01N 1/42; F25D 2201/126

(57) ABSTRACT

A housing for a climate chamber includes a foamed body with an interior volume for receiving a climate chamber insert, an outer wall, and a projection projecting over the outer wall in a normal direction. The housing includes an outer wall margin extending at least sectionally about the outer wall and disposed such that it projects over the outer wall to form an outer wall cavity with the outer wall. The projection is disposed on the outer wall to divide the outer wall cavity into a first cavity and a second cavity. The first cavity can accommodate refrigerant conducting and/or refrigerant delivering components, while the second cavity can accommodate other components of the climate chamber.

### CROSS-REFERENCE TO RELATED APPLICATIONS AND INCORPORATION BY REFERENCE

This application claims the benefit of priority under 35 U.S.C. § 119(a) to German Patent Application No. DE 102024129716.6, filed Oct. 14, 2024, which is hereby incorporated by reference in its entirety.

### FIELD OF DISCLOSURE

The application relates to a housing for a climate chamber as well as a climate chamber.

### BACKGROUND

In the interior volume of a climate chamber specific climatic conditions can be set. Climate chambers are therefore utilized in many fields of natural science and technology in order to be able for example to analyze products or samples under preset climatic conditions.

In such climate chambers fluorinated refrigerants, such as for example the refrigerant R134a, have until now been frequently employed for the heat transfer. In the course of development toward more sustainable and more environmentally friendly products, such refrigerants are increasingly more frequently replaced by natural refrigerants. However, in contrast to the refrigerants utilized until now, many of the natural refrigerants are highly flammable.

Efforts are therefore being made to seal off in particular the refrigerant conducting pipes and components, for example safety valves, within the climate chamber in which there is increased probability of a leak of refrigerant.

To minimize fire hazards in cooling devices it is already known in prior art to isolate heat sources in the devices as much as feasible against the other assemblies. DE 10 2019 216 094 A1 proposes a system in which the machine compartment is delimited by a machine-compartment cover wall and a seal is disposed between the machine-compartment cover wall and the side wall components. However, such separation is tied to high fabrication and assembly expenditures.

CN 111 365 771 A discloses laying the refrigerant conducting lines in foam. The lines, however, are then no longer accessible for maintenance or repair work. For sealing-off potential refrigerant delivering components, such as for example safety valves, such disposition is also not feasible.

### SUMMARY

The application therefore addresses the problem of providing a system which enables sealing-off refrigerant conducting and/or refrigerant delivering components in a climate chamber and, at the same time, can be produced cost effectively.

A housing for a climate chamber comprises a foamed body with an interior volume for receiving a climate chamber insert, an outer wall, an imaginary outer wall normal extending perpendicularly with respect to the outer wall, and a projection projecting over the outer wall in the direction of the normal of the outer wall normal. Unless stated otherwise, here and in the following, by direction of the normal is meant the direction of the outer wall normal pointing away from the interior volume. The interior volume preferably comprises an interior wall opening disposed on the front face of the housing. The outer wall is preferably developed as a rear wall disposed oppositely to the interior volume opening.

The housing comprises an outer wall margin encircling, at least sectionally, the outer wall which outer wall margin is disposed projecting over the outer wall in the direction of the normal such that the outer wall margin and the outer wall form an outer wall cavity. The outer wall margin can delimit the outer wall transversely with respect to the outer wall normal. The outer wall margin preferably extends completely about the outer wall such that the outer wall margin is closed.

The projection is disposed on the outer wall such that the projection divides the outer wall cavity into a first cavity and a second cavity. In the first cavity refrigerant conducting and/or refrigerant delivering components are preferably disposable. In this way the projection can enable sealing-off refrigerant conducting and/or refrigerant delivering components, in particular against further components of the climate chamber which are preferably disposed in the second cavity.

The foamed body is preferably fabricated of a gas-tight foam. The term “gas-tight” preferably refers here and in the following to gas-form refrigerants. Therewith the seepage of refrigerant through the foamed body, in particular through the projection, and therewith seepage from the first cavity into the second cavity, can be avoided. The foam is preferably developed as a closed-cell foam. The foam is preferably developed as a synthetic foam, in particular as a polyurethane foam, ethylene propylene diene monomer foam, silicone foam or neoprene foam.

In a preferred embodiment the foamed body is developed as a one-piece foamed component part. The foamed body can therewith be produced in a single foaming process. For the production preferably only one foaming mold is required. The foamed body can therefore be produced especially cost-effectively. Furthermore, such foamed body can be produced with an interruption-free foam structure.

The projection preferably comprises a first projection end as well as a second projection end and is developed as a rib extending perpendicularly with respect to the outer wall normal from the first projection end to the second projection end wherein the first projection end and the second projection end are each disposed in contact on the outer wall margin. The first projection end and the second projection end are each disposed such that they are in gas-tight contact on the outer wall margin. The first projection end and the second projection end can be joined by means of an imaginary connection line extending in the rib. The connection line can herein be of any shape. The connection line is preferably of L-shape.

The outer wall can comprise a rectangular base with four outer wall edges and the outer wall margin can comprise several margin segments, wherein along each of the outer wall edges one of the margin segments can be disposed. The individual margin segments are preferably disposed such that they border one another gas-tight.

Three of the margin segments can be formed by the foamed body. Two oppositely disposed lateral margin segments as well as one upper margin segment disposed at right angles to the two lateral margin segments of the upper margin segments can preferably be formed by the foamed body.

The housing can comprise a substructure disposed underneath the foamed body, wherein one of the margin segments is formed by the substructure. One of the lower margin segments, disposed oppositely to the upper margin segments, of the margin segments is preferably formed by the substructure. A machine compartment, in particular for receiving a compressor of the climate chamber, can be disposed in the substructure.

The first projection end can be disposed such that it is in contact on a first margin segment of the margin segments and the second projection end can be disposed such that it is in contact on the second margin segment, adjoining the first margin segment, of the margin segments. The first projection end is preferably disposed such that it is in contact on one of the lateral margin segments. The second projection end can be disposed such that it is in contact on the lower margin segment.

In a preferred embodiment the projection comprises a projection front face facing away from the outer wall and the outer wall margin comprises a margin front face facing away from the outer wall, wherein the projection front face and the margin front face are disposed in a common plane disposed perpendicularly to the outer wall normal. The production of the foamed body and/or a common sealing of the margin front face and projection front face can thereby be facilitated.

The housing can comprise at least one securement element in contact on the projection and/or the outer wall margin for securing a housing cover of the housing. The housing cover is preferably disposable opposite the outer wall, and in that location can close the outer wall cavity. Furthermore, the at least one securement element is preferably disposed on the projection front face or the margin front face, respectively. The at least one securement element can be developed as a laminar component part, in particular as a sheet metal part. The at least one securement element can comprise securement bores.

The housing cover is preferably disposable such that it forms a seal on the at least one securement element and/or the projection. The housing cover can, additionally, be in contact on the outer wall margin forming a seal. Therewith preferably no gas seepage between the housing cover and the at least one securement element and/or the projection and the outer wall margin, respectively, is possible. It is especially preferred for the housing cover to be in sealing contact on the projection front face of the projection and/or on the margin front face. The housing cover can comprise a sealing element in contact on the at least one securement element, the projection and/or on the outer wall margin. The at least one securement element, the projection and/or the outer wall margin can correspondingly comprise a sealing element in contact on the housing cover. The sealing element can be developed of sponge rubber.

In a further development the housing comprises a structural component disposed in the projection. The structural component can be foamed into the foamed body. For this purpose the structural component is preferably disposed in the foaming mold before the foaming process. The structural component can be developed as a solid body. The structural component can be developed in particular as a metal insert. The development as a synthetic material insert is also conceivable.

The structural component can comprise a component front face disposed perpendicularly to the outer wall normal, and at least one component bracket disposed on the component front face and pointing toward the outer wall. The component front face is preferably developed as a securement element of the at least one securement element. The at least one component bracket can serve for anchoring the structural component in the foamed body. The at least one component bracket can be developed as precisely one component bracket. The component bracket can be disposed on the component front face such that the structural component has an L- or T-form cross section. The structural component can alternatively comprise two component brackets of the at least one component bracket in this case both component brackets are preferably disposed on the component front face such that the structural component has a U-shaped cross section.

In a preferred embodiment the at least one component bracket comprises a multiplicity of cutouts. The foamed body is preferably disposed such that it engages into the cutouts. The structural component can thereby be especially effectively anchored in the foamed body. The cutouts preferably are filled with the foam of the foamed body during the production of the foamed body. The cutouts can be developed as circular bores.

The at least one component bracket can comprise at least one elbow preferably extending parallel to the component front face. The at least one elbow can also serve for effectively anchoring the structural component in the foamed body.

A climate chamber comprises a housing according to one of the preceding embodiments. Refrigerant conducting and/or refrigerant delivering components of the climate chamber disposed in the outer wall cavity are herein preferably disposed exclusively in the first cavity.

### BRIEF DESCRIPTION OF THE DRAWINGS

An exemplary embodiment will be explained in conjunction with the following Figures. Therein depict:

FIG. 1 a perspective view of an embodiment example of a housing of a climate chamber,

FIG. 2 a rear view of the housing depicted in FIG. 1,

FIG. 3 a perspective view of the foamed body of the embodiment example depicted in FIG. 1,

FIG. 4 a rear view of the foamed body depicted in FIG. 3,

FIG. 5 the view depicted in FIG. 1 with the foamed body not visible,

FIG. 6 the view depicted in FIG. 2 with the foamed body not visible.

### DETAILED DESCRIPTION

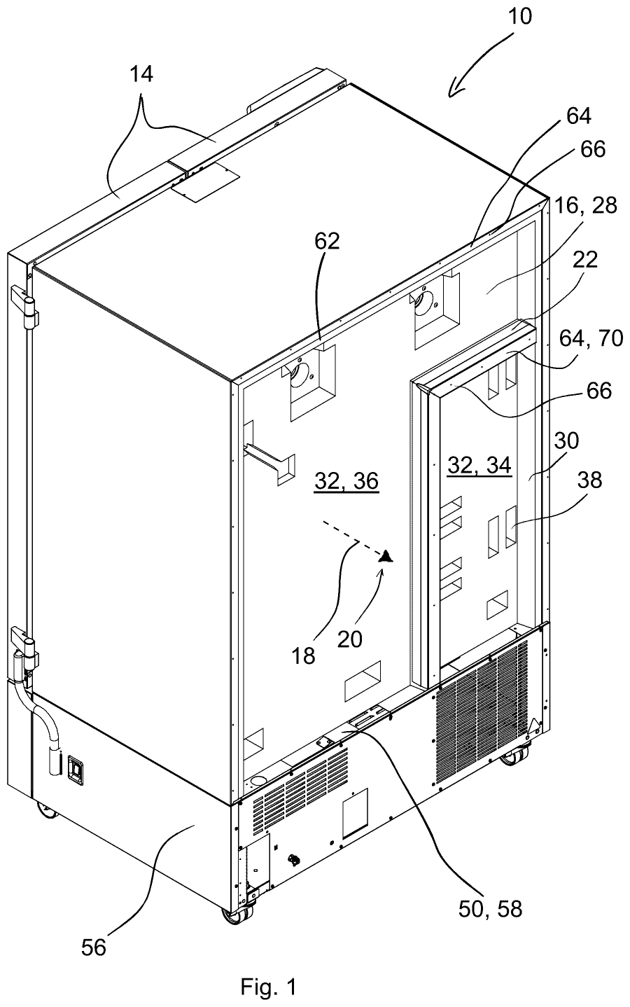

FIGS. 1 to 6 depict various views of an embodiment example. For greater clarity not all reference numbers are used in every Figure.

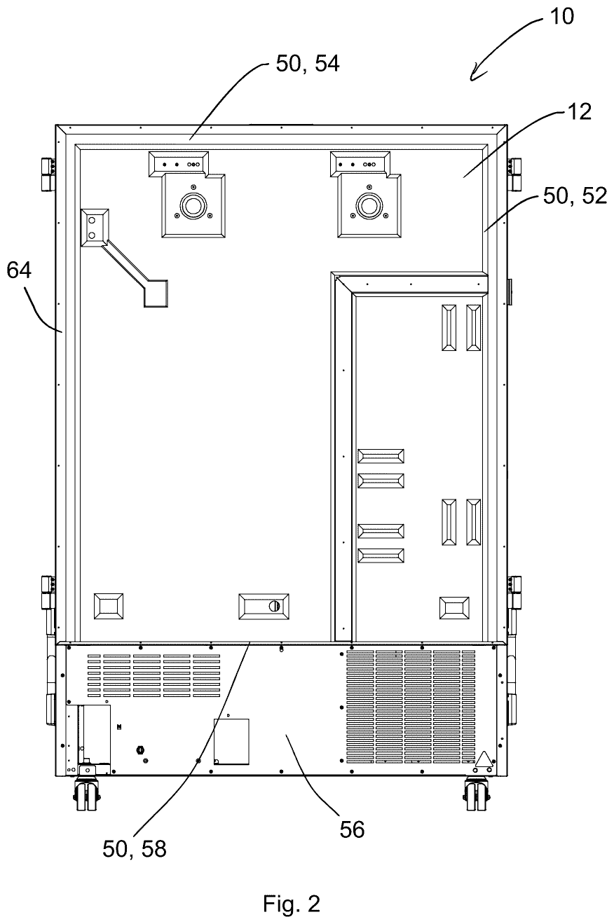

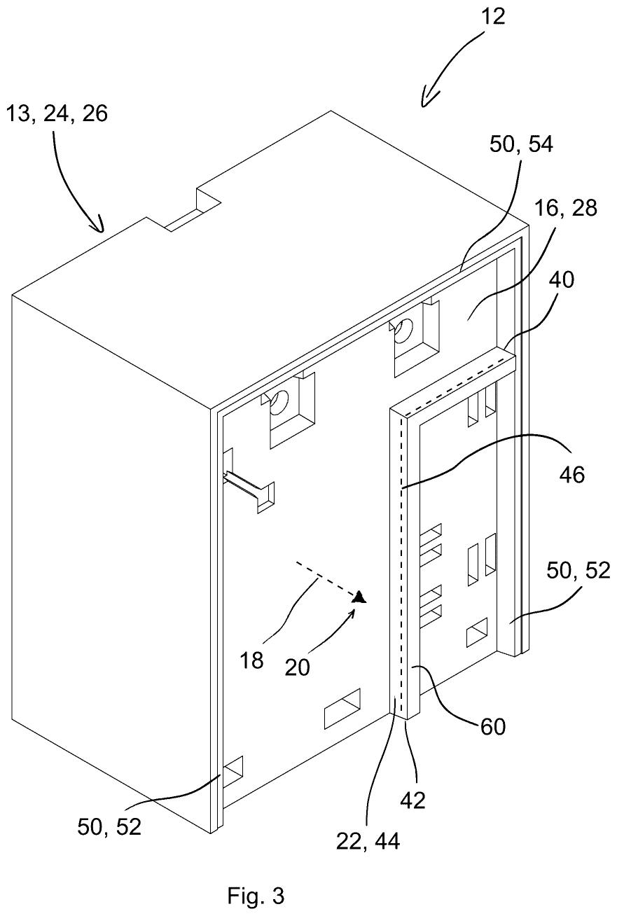

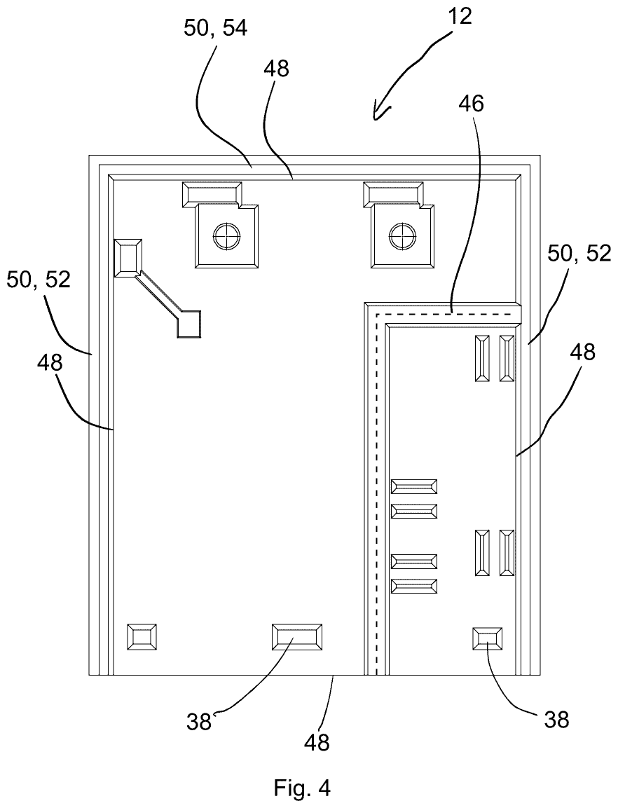

FIGS. 1 and 2 show an embodiment example of a housing 10 of a climate chamber. The housing 10 comprises a foamed body 12 which is depicted separately in FIGS. 3 and 4.

The foamed body 12 comprises an interior volume 13 located interiorly and not visible in FIGS. 1 to 6 for receiving a climate chamber insert.

As FIG. 3 further shows the foamed body 12 comprises an outer wall 16, an imaginary outer wall normal 18 perpendicular to the outer wall 16. The point of the arrow disposed at the outer wall normal 18 signifies a normal direction 20 of the outer wall normal 18 pointing away from the interior volume 13. The foamed body 12 comprises further a projection 22 projecting in the normal direction 20 over the outer wall 16. The interior volume 13 preferably comprises an interior volume opening 26 disposed on a front face 24 of the housing 10. In the representation of FIG. 1 the interior volume 13 is closed by two doors 14. The outer wall 16 is preferably developed as a rear wall 28 of the foamed body 12 disposed opposite the interior volume opening 26.

As shown in FIG. 1 the housing 10 comprises an outer wall margin 30 preferably completely encircling the outer wall 16, which is disposed such that it protrudes over the outer wall 16 in the normal direction 20 such that the outer wall margin 30 and the outer wall 16 form an outer wall cavity 32. The outer wall margin 30 can delimit the outer wall 16 transversely to the outer wall normal 20.

The projection 22 is disposed on the outer wall 16 such that the projection 22 divides the outer wall cavity 32 into a first cavity 34 and a second cavity 36. In the first cavity 34 preferably refrigerant conducting and/or refrigerant delivering components of the climate chamber are disposable. In this way, the projection 22 can enable sealing-off the refrigerant conducting and/or refrigerant delivering components, in particular against further components of the climate chamber which are preferably disposable in the second cavity 36. For the disposition of connections of the components disposed in the outer wall cavity 32, the foamed body 12 can comprise perforations 38 disposed in the first cavity 34 and/or in the second cavity 36.

The foamed body 12 is preferably fabricated of a gas-tight foam such that seepage of refrigerant through the foamed body 12, in particular through the projection 22, and therewith from the first cavity 34 into the second cavity 36, can be avoided. The foam is preferably developed as a closed-cell foam. In particular the depiction in FIG. 3 demonstrates that the foamed body 12 is preferably developed as a one-piece foamed component. For this reason the foamed body 12 can be fabricated in a single foaming process.

FIGS. 3 and 4 demonstrate that the projection 22 preferably comprises a first projection end 40 as well as a second projection end 42 and is developed as a rib 44 extending perpendicularly to the outer wall normal 18 from the first projection end 40 to the second projection end 42 and in each instance in gas-tight contact on the outer wall margin 30. The first projection end 40 and the second projection end 42 can be connected by means of an imaginary connection line 46 extending in the rib 44. The connection line 46 preferably has an L-shape.

As FIGS. 3 and 4 show further the outer wall 16 can comprise a rectangular base with four outer wall edges 48 and the outer wall margin 30 can comprise several margin segments 50, wherein along each of the outer wall edges 48 one of the margin segments 50 can be disposed. The individual margin segments 50 are preferably disposed such that they border one another gas-tight. The three margin segments 50 shown in FIG. 3, viz. two oppositely disposed lateral margin segments 52 as well as one upper margin segment 54 disposed at right angles to the two lateral margin segments 52, are preferably formed by the foamed body 12. The first projection end 40 is preferably disposed such that it is in contact on one of the lateral margin segments 52.

FIGS. 1 and 2 show that the housing 10 can have a substructure 56 disposed underneath the foamed body 12. A lower margin segment 58 disposed opposite the upper margin segment 54 is preferably formed by the substructure 56. The substructure 56 preferably comprises a sheet metal housing. The second projection end 42 can be disposed such that it is in contact on the lower margin segment 58.

In particular FIG. 3 demonstrates that the projection 22 can comprise a projection front face 60 facing away from the outer wall 16 and the outer wall margin 30 can comprise a margin front face 62 facing away from the outer wall 16, wherein the projection front face 60 and the margin front face 62 are disposed in a common plane perpendicular to the outer wall normal 18.

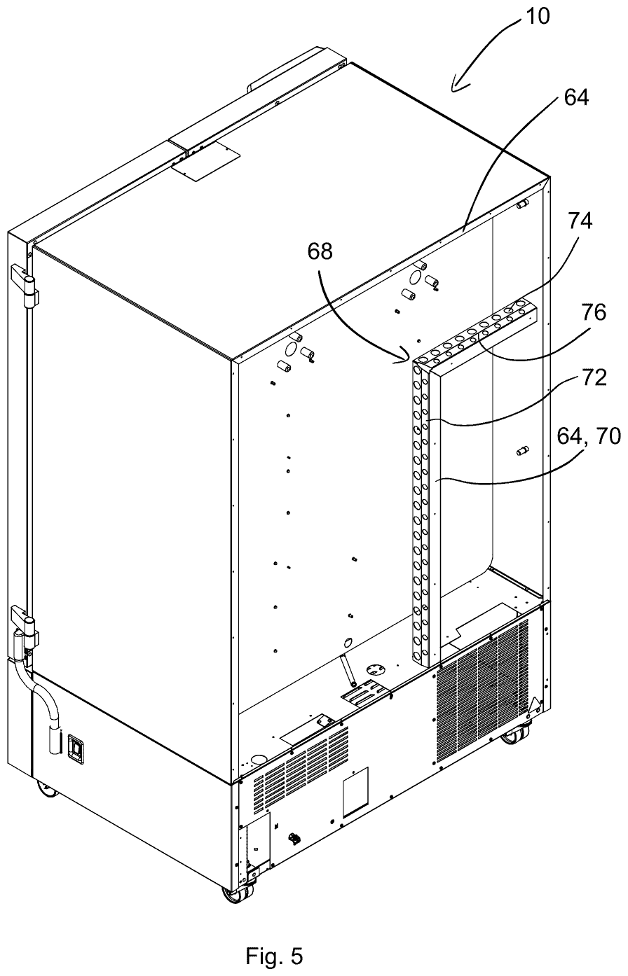

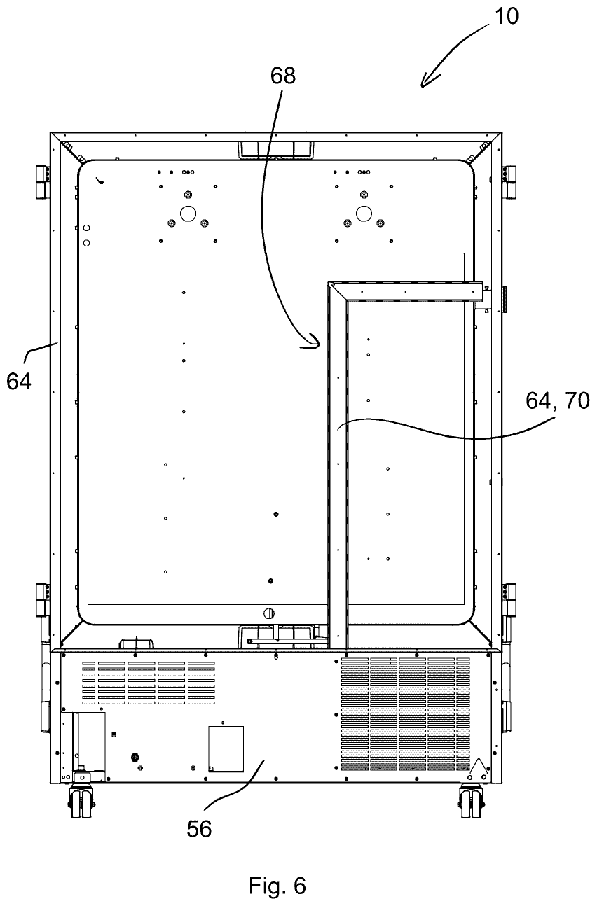

FIGS. 5 and 6 show views of the housing 10 in which the foamed body 12 is not visible, thus is not depicted. FIGS. 5 and 6 demonstrate that the housing 10 comprises several securement elements 64 for securing a housing cover, not shown, of housing 10. The securement elements 64 are developed as laminar components and, as shown in FIG. 1, are disposed in contact with the projection front face 60 and the margin front face 62. The securement elements 64 can comprise securement bores 66. The housing cover is preferably disposable on the securement element 64 such that it forms a seal. The housing cover can, in addition, be disposed on the outer wall margin 30 such that it forms a seal.

As FIGS. 5 and 6 show, the housing 10 can comprise a structural component 68 disposed in the projection 22. The structural component 68 can be foamed into the foamed body 12. The structural component 68 can be developed in particular as a sheet metal insert or as a synthetic material insert.

The structural component 68 can comprise a component front face 70, disposed perpendicularly to the outer wall normal 18, and a component bracket 72 disposed on the component front face 70 and pointing toward the outer wall 16. The component bracket 72 can be disposed on the component front face 70 such that the structural component 68 has an L-shaped cross section. The component front face 70 can herein be developed as the securement element 64 disposed on the projection front face 60. The component bracket 72 can serve for anchoring the structural component 68 in the foamed body 12.

As FIG. 5 shows, the component bracket 72 can comprise a multiplicity of perforations 74 into which the foamed body 12 can engage. The perforations 74 can be developed as circular bores. The component bracket 72 can moreover comprise an elbow 76 extending parallel to the component front face 70. The elbow 76 can also serve for the effective anchoring of the structural component 68 in the foamed body 12.

### LIST OF REFERENCE SYMBOLS

10 Housing
12 Foamed body
13 Interior volume
14 Door
16 Outer wall
18 Outer wall normal
20 Direction of normal
22 Projection
24 Front face
26 Interior volume opening
28 Rear wall
30 Outer wall margin
32 Outer wall cavity
34 First cavity
36 Second cavity
38 Perforation
40 First projection end
42 Second projection end
44 Rib
46 Connection line
48 Outer wall edge
50 Margin segment
52 Lateral margin segment
54 Upper margin segment
56 Substructure
58 Lower margin segment
60 Projection front face
62 Margin front face
64 Securement element
66 Securement bore
68 Structural component
70 Component front face
72 Component bracket
74 Perforation
76 Elbow

We claim:

1. A housing for a climate chamber comprising:
a foamed body with an interior volume for receiving a climate chamber insert;
an outer wall;
an imaginary outer wall normal perpendicular to the outer wall;
a projection projecting over the outer wall in a normal direction of the outer wall normal; and
an outer wall margin encircling at least sectionally the outer wall, the outer wall margin disposed such that it projects over the outer wall in the normal direction such that the outer wall margin and the outer wall form an outer wall cavity,
wherein the projection is disposed on the outer wall such that the projection divides the outer wall cavity into a first cavity and a second cavity.

2. The housing of claim 1, wherein the foamed body is fabricated of a gas-tight foam.

3. The housing of claim 1, wherein the foamed body is fabricated as a one-piece foamed component.

4. The housing of claim 1, wherein the projection comprises a first projection end and a second projection end and is developed as a rib extending perpendicularly to the outer wall normal from the first projection end to the second projection end, wherein the first projection end and the second projection end are each disposed in contact on the outer wall margin.

5. The housing of claim 1, wherein the outer wall comprises a rectangular base with four outer wall edges and the outer wall margin comprises several margin segments, wherein one of the margin segments is disposed along each of the outer wall edges.

6. The housing of claim 5, wherein three of the margin segments are formed by the foamed body.

7. The housing of claim 5, wherein the housing comprises a substructure disposed underneath the foamed body, wherein one of the margin segments is formed by the substructure.

8. The housing of claim 4, wherein the first projection end is disposed such that it is in contact on a first margin segment of margin segments and the second projection end is disposed such that it is in contact on a second margin segment, bordering on the first margin segment, of the margin segments.

9. The housing of claim 1, wherein the projection comprises a projection front face facing away from the outer wall and the outer wall margin comprises a margin front face facing away from the outer wall, wherein the projection front face and the margin front face are disposed in a common plane disposed perpendicularly to the outer wall normal.

10. The housing of claim 1, wherein the housing comprises at least one securement element disposed on the projection and/or on the outer wall margin for the securement of a housing cover of the housing.

11. The housing of claim 10, wherein the housing cover can be disposed on the at least one securement element and/or the projection such that it forms a seal.

12. The housing of claim 1, wherein the housing comprises a structural element disposed in the projection.

13. The housing of claim 12, wherein the structural component comprises a component front face perpendicular to the outer wall normal and at least one component bracket disposed on the component front face and pointing toward the outer wall.

14. The housing of claim 13, wherein the at least one component bracket comprises a multiplicity of perforations.

15. The housing of claim 1, further comprising a climate chamber.

16. A housing for a climate chamber comprising:
a foamed body with an interior volume for receiving a climate chamber insert;
a rear wall formed as part of the foamed body;
an outer wall normal perpendicular to the rear wall;
an integral projection formed as part of the foamed body and projecting over the rear wall in a normal direction of the outer wall normal; and
an outer wall margin encircling at least sectionally the rear wall, the outer wall margin disposed such that it projects over the rear wall in the normal direction such that the outer wall margin and the rear wall form an outer wall cavity,
wherein the integral projection divides the outer wall cavity into a first cavity and a second cavity for spatially separating refrigerant conducting components in the first cavity from other components in the second cavity.
